(19) United States
(12) Patent Application Publication
(10) Pub. No.: US 2014/0077662 A1
(43) Pub. Date: Mar. 20, 2014

(54) PIEZOELECTRIC APPARATUS FOR HARVESTING ENERGY FOR PORTABLE ELECTRONICS AND METHOD FOR MANUFACTURING SAME

(71) Applicant: The Governors of the University of Alberta, Edmonton, AB (US)

(72) Inventors: Jonathan Sierzant Lueke, Sherwood Park (CA); Walied Ahmed Mohamed Moussa, Edmonton (CA)

(73) Assignee: The Governors of the University of Alberta, Edmonton, AB (unknown)

(21) Appl. No.: 14/032,018

(22) Filed: Sep. 19, 2013

Related U.S. Application Data
(60) Provisional application No. 61/702,955, filed on Sep. 19, 2012.

(51) Int. Cl. H02N 2/18

(52) U.S. Cl. CPC H02N 2/188
USPC 310/339

(57) ABSTRACT

This disclosure presents an advanced design of an energy harvester that utilizes a piezoelectric element to convert vibration to electricity. The advanced design is based on a fixed-fixed folded beam. An aqua regia wet etching and PZT sol-gel deposition/patterning processes can be used to manufacture the energy harvester.

### RELATED APPLICATIONS

This application claims the benefit of U.S. Provisional Patent Application No. 61/702,955 filed on Sep. 19, 2012, which is hereby incorporated by reference in its entirety.

### TECHNICAL FIELD

The present disclosure is related to the field of energy harvesters, in particular, fixed-fixed folded beams utilizing a piezoelectric element, and a method for their manufacture.

### BACKGROUND

Energy harvesting is an important developing field in microelectromechanical systems (“MEMS”) research. Energy harvesting can allow for the reduction of the reliance on traditional power schemes, such as batteries, for consumer and personal electronics, and wireless sensors, as well as various MEMS-based sensing applications. Long term MEMS-based biomedical applications, such as permanent implants instrumented with MEMS sensors for various applications are an especially attractive application for energy harvesting. The ability to supplement or replace the power supply of a MEMS-based medical implant would not only increase the battery lifespan of the device, but increase the level of patient care. There are a variety of energy harvesting methods including photovoltaic, micro fuel cells, thermoelectric, electromagnetic, electrostatic, and piezoelectric methods. The variety between these allows for these energy harvesting methods to have application specific advantages and disadvantages between applications. Each method requires a different type of input energy to convert to electricity. For implantation purposes, vibration-based schemes, such as piezoelectric energy harvesters are more universally applicable than the other methods of energy harvesting. Piezoelectric energy harvesting converts ambient vibrational energy into electricity via the piezoelectric effect. Since vibration can be found in various locations throughout the body, piezoelectric microgeneration is an attractive technology for energy harvesting for biomedical applications. Typically, these vibrations are low frequency (>300 Hz) with low amplitude displacements. Therefore, optimizing the dynamics of the piezoelectric harvester is of a great importance.

It has been shown that the performance of piezoelectric energy harvesters is directly tied to the dynamic performance of the structural element used in the device. The most important parameters of the energy harvester are the natural frequency and the strain applied to the piezoelectric elements produced through beam bending. First, the operational frequency of the energy harvester should match the first natural frequency of the structural member of the energy harvester. This ensures that the maximum deflection and strain on the piezoelectric film is achieved at the operational frequency. Second, the natural frequency of the energy harvester should be as low as possible. The lower the frequency, the more likely the structure of the energy harvester will be actuated by ambient vibrations present in-situ. Additionally, displacements and strains applied to the films at lower frequency will be higher magnitude, allowing for higher voltage and power output. Therefore, the most important parameters of the piezoelectric energy harvester are the natural/operational frequency and the strain applied to the piezoelectric elements produced through beam bending.

Typically, cantilever-based energy harvesters dominate the piezoelectric-based microgeneration, due to their well-known dynamics and ease of optimization. However, the typical method of optimizing natural frequency is increasing the length of the beam; however the length based residual stresses increase, hindering or reversing attempts at frequency optimization.

Piezoelectric energy harvesters convert vibration induced displacements to electricity via the piezoelectric effect. Piezoelectric materials have an inherent lack of inversion symmetry, which allows aligned electric dipoles to form within the material. When the piezo material is stressed, the electrons become mobile within the crystal, generating a potential difference, and hence a current flow. With respect to MEMS-based energy harvesting, there are a variety of methods of producing electricity from vibration, including utilizing piezoelectric beams, fibers, and membranes. Piezoelectric fibers adhered to a strained surface convert directly applied strains into electricity. Piezoelectric membranes can convert a pressure difference across the membrane into electricity. Piezoelectric-based beam energy harvesters convert the inertia and momentum of a mechanical vibration into electricity. The most typical configuration of beam based energy harvesting utilizes a cantilever beam and a proof mass to convert the applied vibration into a mechanical strain that can be directly applied to a piezoelectric element to produce a voltage.

The power produced by the piezoelectric energy harvester is based upon the natural frequency response of the generator. The lower the natural frequency, the more power produced. The closer the natural frequency of the device is to the input frequency of the vibration the energy harvester is exposed to, the higher the power output is.

Platinum is a common microfabrication material used for electrical contacts and electrodes, in biomedical, energy harvesting, and general microelectromechanical (MEMS) fields. Patterning Platinum through etching is difficult, due to the potential dangers with etching with Aqua Regia. The alternative patterning technologies, such as lift-off of platinum films, may produce non-optimized non-planar platinum films that may not be suitable for many applications.

It is, therefore, desirable to provide a piezoelectric energy harvester, and a method for manufacturing the same, that overcomes the shortcomings in the prior art.

### SUMMARY

In some embodiments, a piezoelectric energy harvester is provided that includes means to reduce the natural frequency of the energy harvester that can improve the power output of an energy harvester so as to be matched to a specific target generation application. When the natural frequency of the harvester is matched or lowered, the displacement experienced by the harvester can be maximized, thereby maximizing the strain applied to the piezoelectric element, and therefore maximizing the voltage produced. In some embodiments of the invention, a folded spring geometry can be used that can solve two major problems that occur in beam-based energy harvesting: the reduction of natural frequency, and the relaxation of residual stresses. The folded spring structure can increase the effective length of the beam element that experiences bending, allowing for the reduction of stiffness of the structure to occur without increasing the overall footprint of the device significantly. The folded beam can dynamically act as an unfolded beam with similar effective length (length that undergoes bending). This increase of length can cause the stiffness of the beam to decrease, and thereby cause a decrease in natural frequency.

In addition to the reduction of natural frequency, the folded structure, when used in a fixed-fixed configuration, can allow for the relaxation of fabrication-induced residual stresses. In cantilever and beam based energy harvesting, residual stresses can be a significant problem. Residual stresses are typically length-dependant, and become magnified with long, slender MEMS-based cantilever beams. This behaviour can reduce the amount of geometry-based stiffness reduction that is possible with beam-based MEMS geometries. The residual stresses will apply a pre-load to the beam structures, typically hindering motion and causing strain stiffening. This preload is typically observed in MEMS-devices as an out-of-plane curled beam. In an energy harvesting application, this residual stress stiffening will increase the natural frequency of the device and decrease the amplitude of free vibration, therefore reducing maximum strain applied/power output. The energy harvester of this embodiment utilizes a folded spring geometry in a fixed-fixed configuration to allow for equal expansion/contraction of each of the elastic elements and rotation of the suspended mass to completely relax any residual stresses developed in fabrication. This ultimately allows for the further reduction of natural frequency to meet low operational frequency applications, such as walking/running (˜1-5 Hz), or various biomedical and portable electronics applications (˜30-200 Hz).

In some embodiments of the invention, the apparatus can comprise a variety of plug and play energy harvesting systems. The energy harvesters can be tailored to a variety of applications by utilizing fixed-fixed folded elastic spring elements of the aforementioned design. Existing packaging schemes can be applied to integrate the energy harvester into a variety of common electronics packages. These packages can include placement directly on flexible or printed circuit boards, dual inline packages, or a variety of pin grid array packages. This allows for the complete customization of the designed energy harvester solution, allowing for seamless plug and play integration into a variety of existing electronic systems with conventional electronic components to augment or replace existing battery based power schemes.

In some embodiments of the invention, a fabrication process is provided that can allow for the fabrication of piezoelectric energy harvesters. The process can allow for the use of two fabrication processes for the microfabrication of piezoelectric energy harvesters in a general OEM fabrication facility, rather than a closed, captive fabrication facility. The processes can include (and are not limited to): wet oxidation, wet etching of silicon oxide, deep reactive ion etching, photolithography, and sputtering of various metals. The other processes used and developed within this microfabrication recipe can include an Aqua Regia wet etching and PZT (lead zirconate titanate ceramic piezoelectric material) sol-gel deposition, lift off or patterning.

Aqua Regia is a wet etching technique used to etch platinum films. The platinum film is required in order to act as an adhesion/electrode layer for the PZT film. Typically, platinum films are patterned through a lift-off process, where photoresist is used as a sacrificial layer to prevent the adhesion of platinum to the required titanium adhesion layer and to remove the excess platinum. The lift-off process used can be difficult for metallic films, causing film artifacts and uneveness. In addition, the lift-off process generally is not as clean as the Aqua Regia etch process. Residual metal particles left from the lift off process can cause short circuits and a variety of other fabrication problems. Additionally, the wet etch, using equipment such as the Aqua Regia etch system, can be suitable for batch fabrication.

The typical PZT film used in a deposition process is sub-micron. In some embodiments of the invention, the method of depositing PZT sol-gel films can result in an approximate four-fold increase in film thickness over previously used methods. This increase in film thickness will cause an increase in strain applied to the PZT film, thereby increasing the voltage produced by the film. Additionally, the sol-gel process can allow for the deposition of PZT films without the additional cost of a dedicated sputtering/chemical vapour deposition (“CVD”) system. Generally speaking, the PZT deposition process can have the capability to contaminate expensive processing equipment with lead and lead-based compounds, causing potential contamination of other devices or processes using the same equipment. In industry, PZT-based devices require a “captive” fabrication facility; therefore they are not typically suitable for OEM manufacturing facilities. The fabrication recipe according to the invention allows for the production of PZT-based energy harvesters with minimal equipment costs and contamination concerns. Additionally, this process can act as a generic process to develop a variety of piezoelectric energy harvester designs, with different geometry and device thicknesses.

This microfabrication process allows for the production of microgenerators that are “plug-and-play” components, allowing for the augmentation of existing high performance rechargeable battery systems for a variety of applications including consumer electronics, military applications, wireless sensing networks and biological sensing networks.

In some embodiments of the invention, an aqua regia etch system (“ARES”) can allow for safe and consistant use of the microfabrication process. Chemical byproducts of the etch, such as chlorine gas, can be controlled and disposed of, safeguarding the user of the system from exposure. Increased etch rates through the controlled heating of the aqua regia solution. Etch rates as high as 12-15 nm/min can be achieved, where unheated aqua regia etches typically have 3 nm/min etch rates. Easy disposal of waste aqua regia is provided through quenching and aspiration, without exposing the user to the solution. The etch can allow for a high degree of planarity to the platinum film for applications where having a planar platinum film is important, such as a lower electrode layer in a piezoelectric stack. Patterning through lift-off typically leaves curved top surfaces to films, rather than planar top surfaces; and ARES provides a cost-effective alternative for plasma etching/complicated lift off for platinum films.

Broadly stated, in some embodiments, an apparatus is provided for harvesting energy from mechanical motion, comprising: a piezoelectric transducer configured for converting mechanical motion into electrical energy, wherein the transducer further comprises: a piezoelectric beam element that is folded into a structure that comprises at least two parallel beam lengths that define an intervening void space, a proof mass disposed at a first end of the beam element, and a clamp element disposed at a second end of the beam element; and a storage element for storing electrical energy produced by the transducer.

Broadly stated, in some embodiments, an apparatus is provided for harvesting energy from mechanical motion, comprising: a piezoelectric transducer configured for converting mechanical motion into electrical energy, wherein the transducer further comprises: a piezoelectric beam element that is folded into a structure that comprises at least two parallel beam lengths that define an intervening void space, a first clamp disposed at a first end of the beam element, and a second clamp element disposed at a second end of the beam element; and a storage element for storing electrical energy produced by the transducer.

Broadly stated, in some embodiments, a method is provided for manufacturing aforementioned apparatuses, the method comprising the step of using an Aqua Regia etching and lead zirconate titanate (“PZT”) sol-gel deposition/patterning process to manufacture the apparatuses.

### DESCRIPTION OF THE FIGURES

FIG. 1 is a plan view representation of embodiments of array-based folded spring energy harvesters according to the invention.

FIG. 2 is a plan view representation of embodiments of folded spring energy harvesters according to the invention.

FIG. 3 shows the general microfabrication process that may be used for the production of the folded fixed-fixed energy harvesters.

FIG. 4 is another representation of embodiments of folded spring energy harvesters according to the invention.

FIG. 5 is a representation of further folded spring energy harvesters according to the invention.

FIG. 6 is a representation of a cantilever-based energy harvester.

FIG. 7 is a representation of a lumped one dimensional spring system.

FIG. 8 is a representation of the folded spring concept according to the invention.

FIG. 9 is a plan view representation of the parameterization used in the optimization of the structure of the folded spring energy harvester according to the invention.

FIG. 10 is a representation of a single folded spring energy harvester according to the invention and its layered composition.

FIG. 11 is a representation of packaging schemes used to integrate the harvesters into larger electronic systems.

### DETAILED DESCRIPTION OF EMBODIMENTS

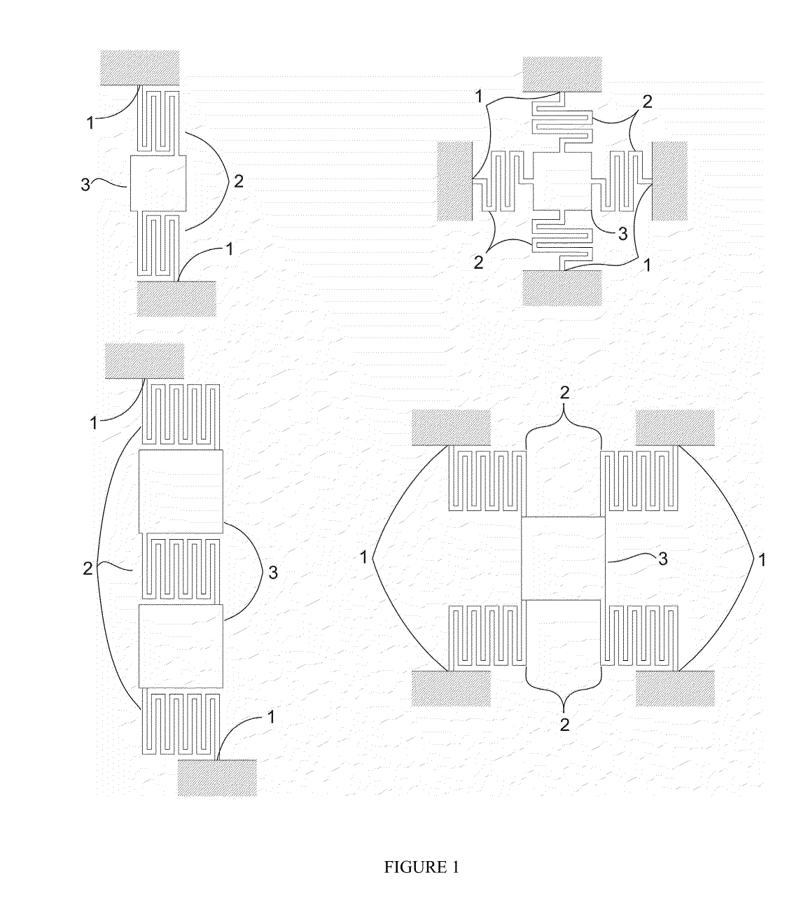

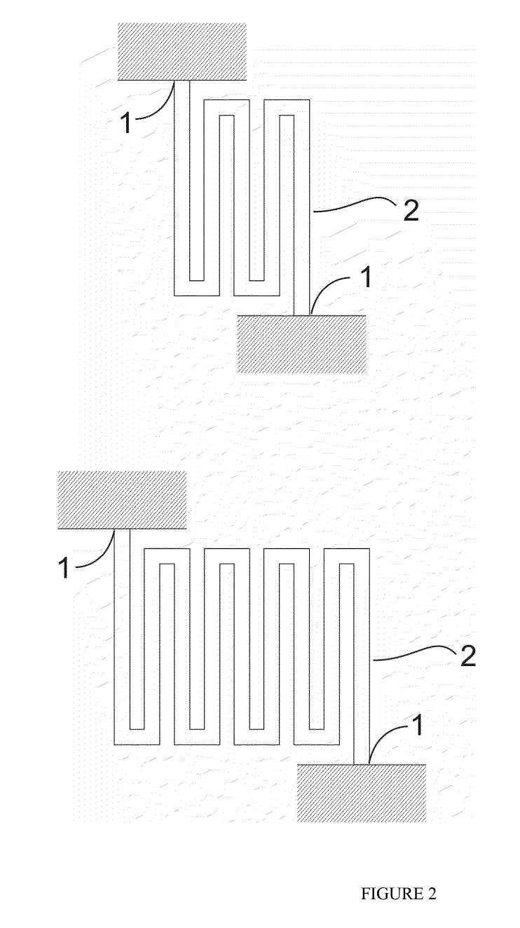

The energy harvester according to the invention, and as shown in FIGS. 1 and 2, includes a proof mass (3), which is in a state of suspension, and is excited by the occurrence of vibrations. The proof mass (3) is connected to beam or spring elements (2) as described in more detail below. Clamps (1) are present on both sides of the proof mass (3) holding the beam element (2) in position relative to the package. The energy generated by the harvester is stored in a storage element, such as a battery for immediate or later use.

The folded beam element (2) includes a plurality of beams arranged in parallel, with further beams connecting the parallel beam elements at an end thereof. The parallel beam elements (2) define a void between them thereby allowing for vibration.

As shown in FIG. 6, a cantilever based energy harvester includes a clamp (70) cantilever beam (71) with one or more piezoelectric elements (72) with a proof mass (73). As the beam vibrates, the piezoelectric elements (72) convert the strain applied from the bending of the beam (71) into electricity via the piezoelectric effect. The proof mass (73) helps in reducing the natural frequency of the harvester and increasing the displacement during bending, maximizing the strain applied on the piezoelectric elements (72).

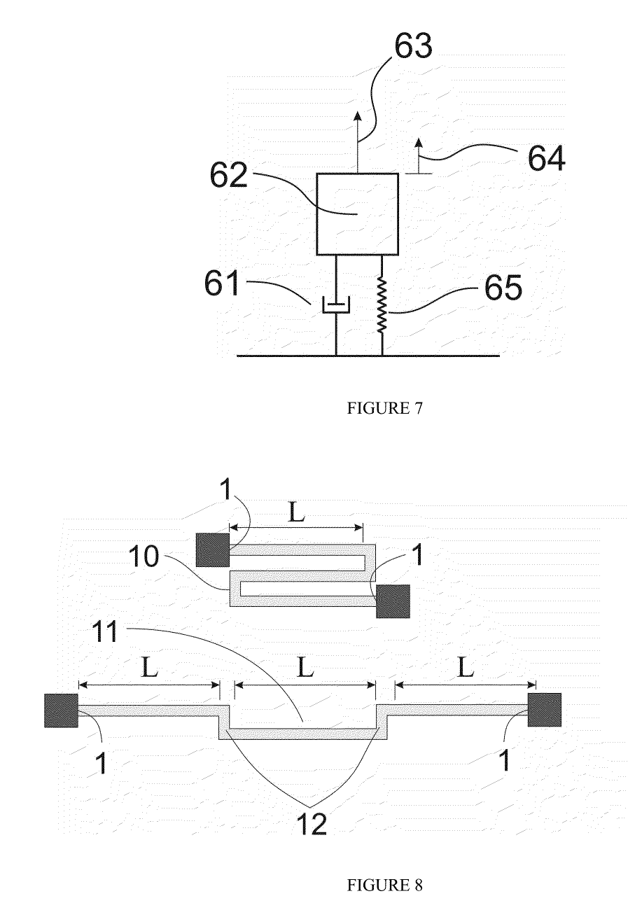

The optimization of the frequency response of the energy harvester can be undertaken in two major ways, reducing the mechanical stiffness and adding inertial mass to the system. This can be easily seen by expressing the dynamics of the piezoelectric energy harvester as a linear, one dimensional vibration problem, as shown in FIG. 7.

FIG. 7 is a representation of a lumped one dimensional spring system. This generalized model includes a damper (61), a mass (62), an applied force (63), the displacement of the system (64) and the spring stiffness of the system (65). This one dimensional generalization of the system is useful in simplifying complex structural situations by combining a variety of structural parameters to fit a classical model.

The piezoelectric energy harvester as show in FIG. 7 can be represented (with some assumptions) as a simple linear mass/spring/damper system, with effective masses (mₑ), spring stiffnesses (kₑ), damping (cₑ), displacement (x) and applied forces (F(x)). The effective masses/stiffnesses/damping can be lumped using the below equations for various geometric configurations:

$${m}_{e , cantilever} = M + 0.23 m$$

$${k}_{e , parallel} = {k}_{1} + {k}_{2} + … + {k}_{n}$$

$${k}_{e , series} = \frac{1}{{k}_{1}} + \frac{1}{{k}_{2}} + … + \frac{1}{{k}_{n}}$$

$${c}_{e , parallel} = {c}_{1} + {c}_{2} + … + {c}_{n}$$

$${c}_{e , series} = \frac{1}{{c}_{1}} + \frac{1}{{c}_{2}} + … + \frac{1}{{c}_{n}}$$

As can be seen above, the geometry and spacial layout (series/parallel) of the energy harvester plays a very important role in the frequency response of the system. The equation of motion and the natural frequency of this system can be expressed as:

$$F ( x ) = {m}_{e} \ddot{x} + {c}_{e} \dot{x} + {k}_{e} x \qquad {ω}_{n} = \sqrt{\frac{{k}_{e}}{{m}_{e}}}$$

A means of reducing the natural frequency of the energy harvester is to reduce the stiffness of the mechanical elements of the energy harvester. For cantilever based systems, the stiffness of the energy harvester can be expressed as:

$$k = \frac{{EWH}^{3}}{4 {L}^{3}}$$

Wherein k is the beam stiffness, E is the Young's Modulus, W is the beam width, H is the beam thickness, and L is the length of the cantilever beam. The stiffness of cantilever based piezoelectric generators can be reduced by decreasing the thickness or increasing the length of the cantilever. In the case of reducing the thickness of the cantilever resulting in a “thin” structure (H<<W), the residual stress of the cantilever becomes length dependant causing increased curvatures and non-linear spring effects at longer lengths and deflections approaching the cantilever thickness. Even though the residual stress is relieved through the at-rest curvature of the beam, this increased curvature will stiffen the system, since the vibration experienced by the energy harvester will have to overcome the initial residual pre-stress of the cantilever.

The residual stress of a typical simple fixed-fixed beam is critical to the mechanical stiffness. The additional constraint of a second fixed beam end prevents much of the curvature-based stress relaxation that can take place. The residual stress problem experienced by thin fixed-fixed beam systems can be overcome by using a folded fixed-fixed beam, which allows for the relaxation of residual axial stresses produced from fabrication. The individual beam segments are not constrained axially, and are allowed to expand or contract the same length and rotate to relieve, any beam curvature/residual stresses. The mechanical stiffness of a clamped-clamped beam can be expressed as:

$$k = \frac{{π}^{4}}{6} [ \frac{{EWH}^{3}}{{L}^{3}} ]$$

Where k is the stiffness of the beam, E is the modulus of elasticity, W is the width of the beam, H is the height of the beam, and L is the length of the beam.

Folded springs in a “fixed-fixed” beam configuration provide both structural support and required cyclic movement with high accuracy and reliability. This folded spring concept, used in a fixed-fixed configuration is the basis of the mechanical element that is the core of the stiffness-optimized energy harvester design. By folding the beam (2), as shown schematically by the representations of energy harvesters according to the invention in FIGS. 1 and 2, the effective length of the beam (2) exposed to bending is increased.

The arrays as shown in FIG. 1 typically includes a number of proof masses (3) and silicon folded springs, or beams, with piezoelectric elements (2) that are clamped using clamps (1) to the silicon wafer on either end. A variety of configurations of masses (3) and piezoelectric spring elements (2) are possible to meet a variety of requirements as shown in the four representations. The folded piezoelectric spring (3) includes a number of parallel beam lengths that undergo bending during actuation. The folding and addition of numerous parallel lengths allows for the length of beam subject to bending to be increased, therefore reducing the stiffness of the structure, lowering the natural frequency. The addition of masses (3) to the system further reduces the natural frequency, allowing for higher strains to be placed upon the piezoelectric elements, producing higher electrical output.

FIG. 8 is a representation of the folded spring concept according to the invention. The folded fixed-fixed spring is shown folded (10) and unfolded (11). The folded spring (10) acts mechanically the same in both scenarios. The connections (12) between each beam of length “L” are rigid in this configuration and only undergo a minimal amount of torsion, not contributing to the mechanical stiffness of the spring. The folding of the spring allows for long effective bending length springs without the problematic length-based problems typically encountered for thin MEMS-based structures.

The stiffness of the beams shown in FIG. 8 can be expressed by:

$$k = \frac{{π}^{4}}{6} [ \frac{{EWH}^{3}}{{( {L}_{eff} )}^{3}} ] = \frac{{π}^{4}}{6} [ \frac{{EWH}^{3}}{{( 3 L )}^{3}} ] = \frac{{π}^{4}}{6} [ \frac{{EWH}^{3}}{{( nL )}^{3}} ]$$

wherein L is the length of the beam and n is the number of beam lengths included within the folded beam structure. As can be seen from the above equation, as the number of folds of the beam is increased, the effective length increases, decreasing the overall stiffness of the beam. This assumes that the members joining the individual beams of the folded spring structure are rigid, undergo no appreciable bending, and only contribute to the stiffness of the structure slightly as torsional springs.

Given that the reduction of scale generally increases the natural frequency of the system, the major parameter defining the stiffness of the folded spring system, the effective beam length nL, will scale as s⁻³ relative to the stiffness, thereby significantly decreasing the stiffness of the system as the effective beam length is increased.

Fixed-fixed beams are stiffer per unit length than cantilever beams, as folding the beam allows for the significant increase of the effective length of the beam, reducing the natural frequency while maintaining the stability and resistance to residual stresses. With a folded beam, each beam segment is free to expand longitudinally equally, rotate, or displace in any direction to lessen residual stresses.

The folded spring structure according to the invention provides for lowering the natural frequency of the harvester. Two classes of embodiments of the apparatus are disclosed herein.

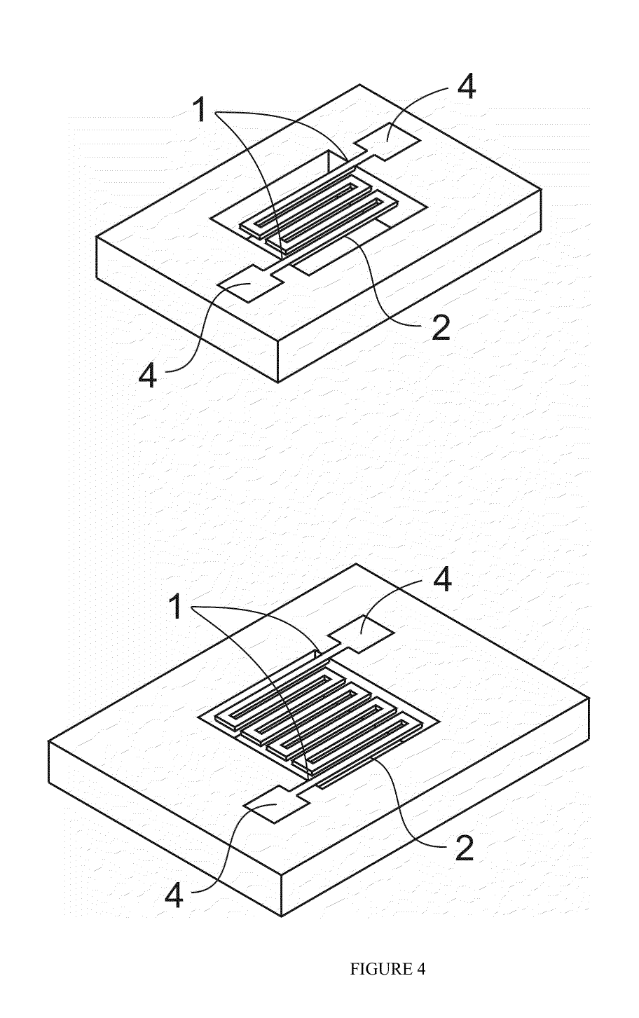

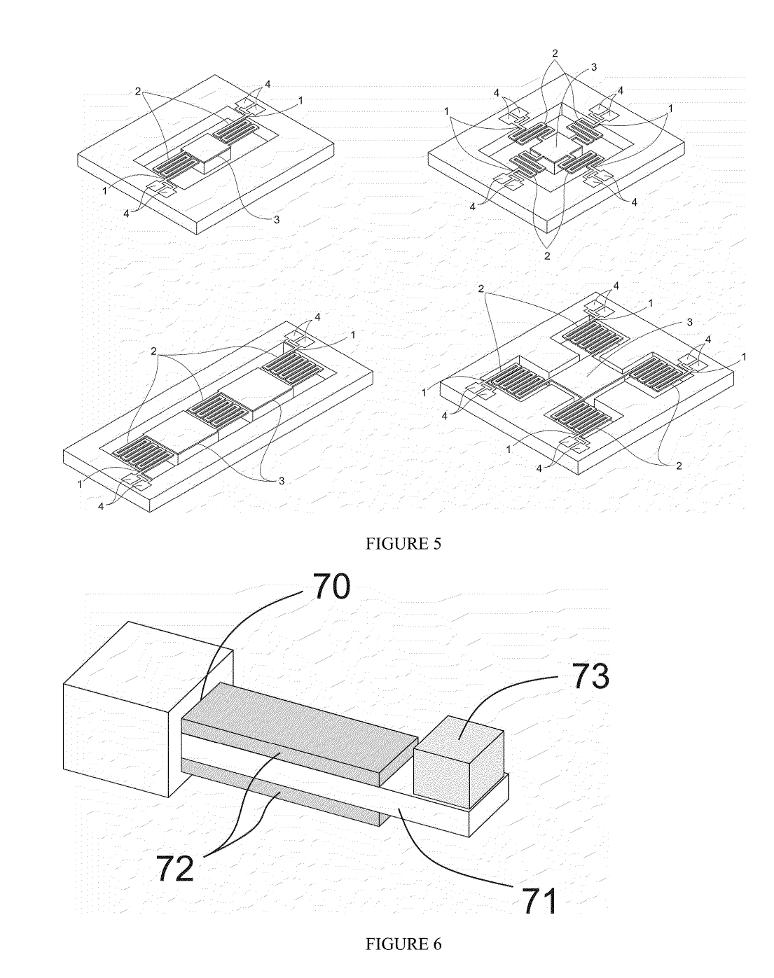

The first class of harvesters (defined as Class I Energy Harvesters herein as shown in FIG. 4) focus on the folded springs that are elastic members for piezoelectric energy harvesters. These allow for universal microfabrication process for PZT-based energy harvesters. The second class of harvesters (defined as Class II Energy Harvesters as shown in FIG. 5) includes arrays of masses and folded spring energy harvesters that have a target operational/natural frequency of 30-300 Hz, and power output goals of at least 125 μW.

As shown in FIGS. 4 and 5, a fixed-fixed folded spring energy harvester includes a single silicon folded spring with a piezoelectric spring or beam (2) that is clamped with clamps (1) on either end to the silicon wafer. The folded piezoelectric spring (2) includes of a number of parallel beam lengths that undergo bending during actuation. The folding and addition of numerous parallel lengths allows for the length of beam subject to bending to be increased, therefore reducing the stiffness of the structure, lowering the natural frequency. The electricity is collected through the contact pads (4) of the upper and lower electrodes of the harvester.

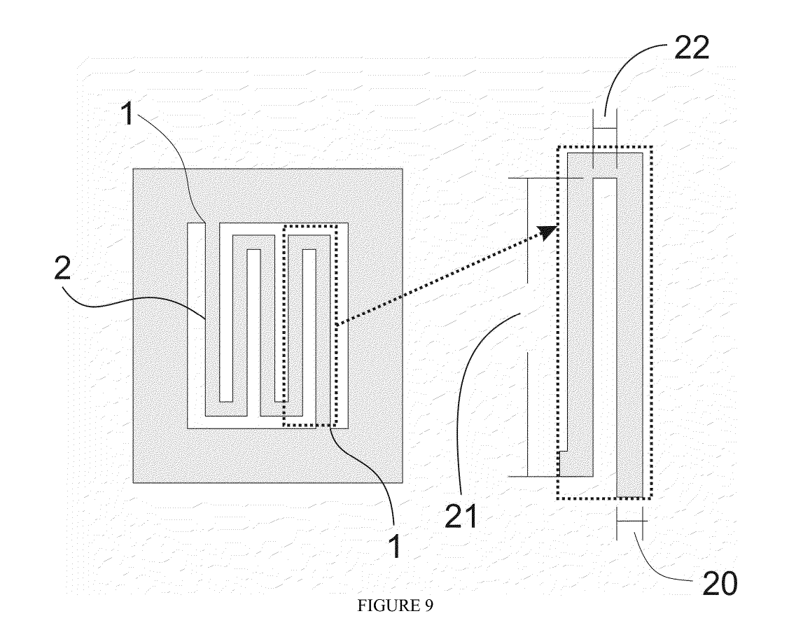

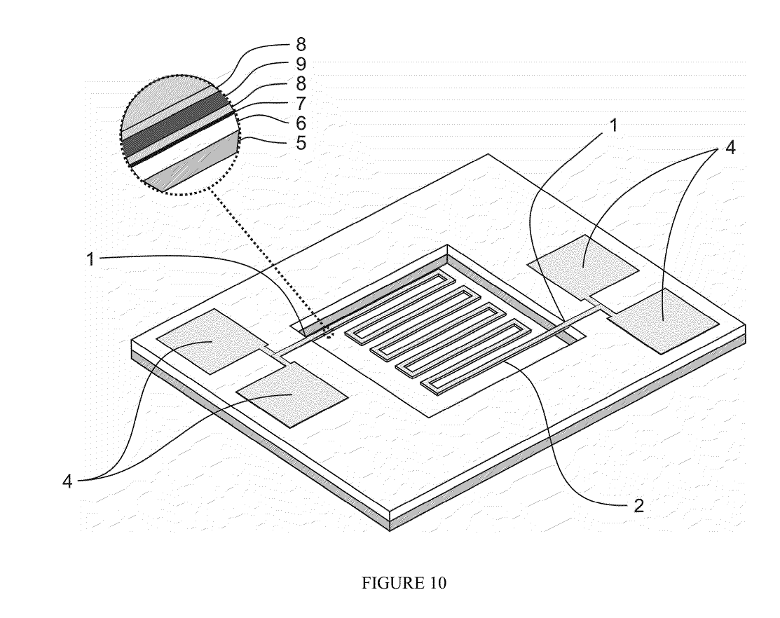

The geometry of a harvester according to the invention can be parameterized into a small number of independent variables as shown in FIG. 9. The fixed-fixed spring (2) is clamped with clamps (1) to a bulk material. The three parameters that define the entire geometry of the folded spring are the width of the beam (20), the internal beam length of the spring (21), and the internal gap of the fold (22). Any point of the geometry of the folded spring can be defined by these three parameters.

Every vertex of the geometry of the folded spring (2) can be defined by four variables: three variables determining the planar geometry and the thickness of the spring. These variables are the width of the folded spring throughout the entire length of the beam; the gap between each beam in the fold, and the length of the beam in the fold.

The length of the beam in the fold and the thickness of the folded spring are the dominant parameter that can account for the largest decrease of the stiffness of the folded spring. Additionally, increasing the number of folds in the spring, by adding additional beams decreases the stiffness of the harvester. Table 1 summarizes of the results of these parameters.

TABLE 1
Summary of the Qualitative Results of the Parametric
Study of Folded Spring Energy Harvesters

| Parameter | Effect on Natural Frequency |
|---|---|
| Beam Width | Decreases slightly as Width |
| | Increases (Mass Addition) |
| Internal Width | Decreases slightly as Width |
| | Increases (Mass Addition) |
| Beam Length | Decreases Significantly as |
| | Length Increases (Stiffness |
| | Decrease/Mass Addition) |
| Thickness | Decreases Significantly as |
| | Thickness Decreases |
| Number of | Decreases Significantly as |
| Folds | Number of Folds Increase |

A piezoelectric energy harvester according to the invention requires a piezoelectric thin film to convert the displacement and strain into electricity through the piezoelectric effect. Three materials can be deposited as thin films for this application, Lead Zirconate Titanate (PZT), Zinc Oxide, and Aluminum Nitride. In terms of microfabrication, Zinc Oxide and Aluminum Nitride are less complicated and have fewer equipment contamination issues than PZT. The material properties of these thin films are shown below in Table 2:

TABLE 2
Thin Film Piezoelectric Materials [1]

| Thin Film | | | Piezoelectric | Piezoelectric |
|---|---|---|---|---|
| Piezoelectric | | Fabrication Difficulty | Coefficient d₃₁ | Coefficient d₃₃ |
| Material | Fabrication Method | (Easy/Medium/Difficult) | (pC/N) | (pC/N) |
| Aluminum | Sputtering | Easy (Sputtering) | 0.7 | 2.0 |
| Nitride | | | | |
| Lead Zirconate | Sputtering, | Easy (Sputtering) | −60 (PZT-2) | 152 (PZT-2) |
| Titanate (PZT) | Sol-Gel Deposition, | Medium (Sol-Gel | −171 (PZT-5) | 374 (PZT-5) |
| | Metal Oxide Chemical Vapor | Deposition, MOCVD) | −220 (PZT-5J) | 500 (PZT-5J) |
| | Deposition (MOCVD) | | | |
| Zinc Oxide | Sputtering | Easy (Sputtering) | −5.43 | 11.67 |

As can be seen from the above table, the piezoelectric coefficients for a variety of PZT materials are much higher in magnitude than Aluminum Nitride and Zinc Oxide thin films. For power generation applications higher piezoelectric coefficients, especially the d₃₁ coefficient, are desirable. In addition, although PZT can be more complicated to fabricate, the variety of materials and deposition technologies allows for greater control over the material properties and deposition thicknesses of the film which is beneficial for further optimization of the generator itself.

The sol-gel PZT deposition process can use a repetitive spin-pyrolize cycle to build up the thickness off the PZT film. The sol-gel may be spun and pyrolized to build up a film thickness of approximately 0.24 μm and then annealed at 700° C. for crystallization. This process can be repeated to build up additional PZT thickness in steps of 0.08 μm (the thickness built up with one spin-pyrolize cycle) as long as the film is annealed every three spin-pyrolized cycles. The resulting PZT film resembles silicon oxide visually, with a film color that depends highly on the thickness of the layer.

To accommodate the PZT film, the energy harvester uses a variety of different materials and micromachining processes for adhesion and electrical isolation. For adhesion of PZT to a silicon wafer, silicon dioxide, titanium and platinum layers are used. The platinum is required as an adhesion/electrode/seed layer for the PZT film. The titanium layer is used as an adhesion layer for the platinum film. The silicon dioxide is used as an adhesion layer for the titanium and as an electrical insulation layer in order to prevent charge leakage into the silicon substrate.

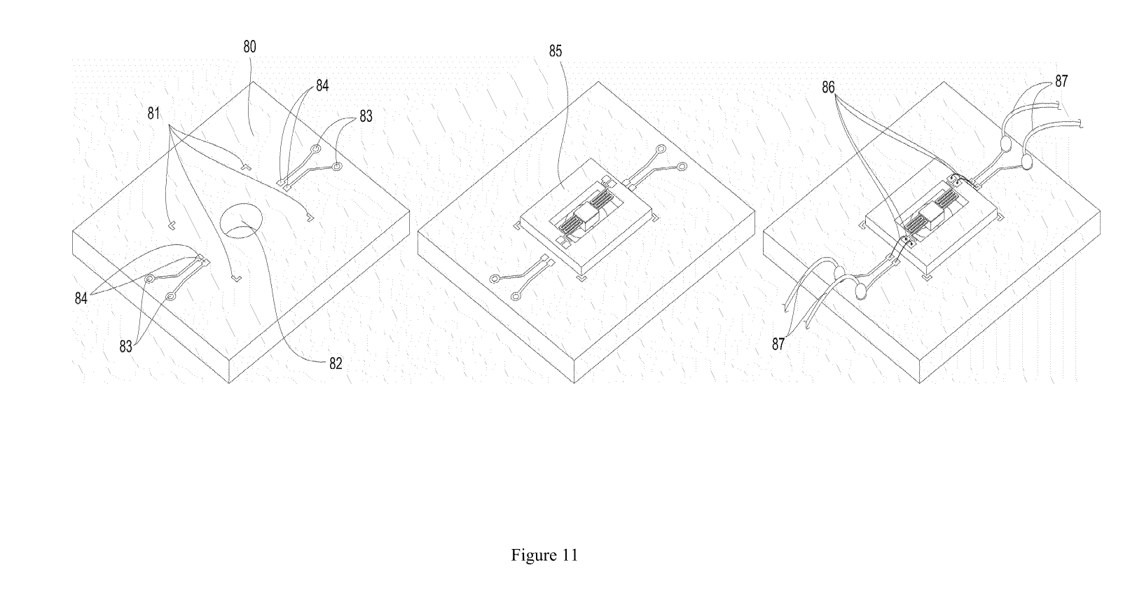

An arrangement of layers produces a specific stack of materials shown in FIG. 10. The spring element (2) is clamped with clamps (1) to the bulk silicon on either end of the spring element. Electrodes (4) are required to capture the electricity produced from this energy harvester. The layers that are required to produce this harvester include the structural silicon (5), the silicon oxide diffusion and leakage barrier (6), the titanium adhesion layer (7), the lower platinum electrode (8), the PZT layer (9), and the upper platinum electrode (8). The silicon oxide layer (6) is required to prevent diffusion of materials and electricity into the silicon. The titanium (7) and platinum are required to promote the adhesion of the PZT to the device. The platinum electrodes are required to collect the electricity produced by the motion of the harvester.

In addition to the layered structure, a stepped profile buffers against alignment and microfabrication errors and prevents short circuiting of the bottom and top electrodes. The alignment of each of these layers in microfabrication through photolithography is a manual operation, limited to the resolution of the optical systems available for alignment.

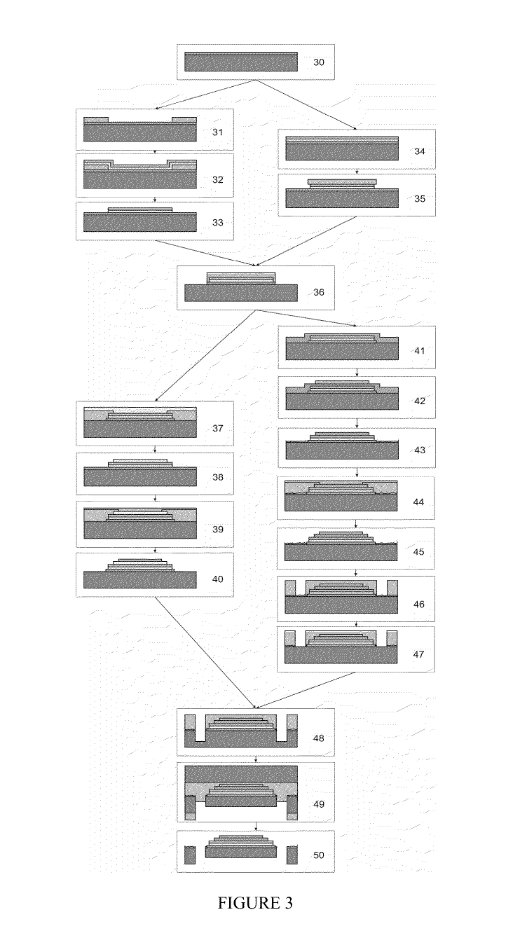

The microfabrication process flow is shown in FIG. 3. The process begins with a double side polished <100> silicon wafer that is cleaned with piranha and has silicon oxide deposited on the top surface (30). The necessary metallic layers can be then deposited and patterned using either lift-off process (31-33) or an Aqua Regia Wet Etch (34-35). For Titanium/Platinum both methods are acceptable. The lift-off process begins with the deposition of a sacrificial photoresist (31). The metal layers are then deposited (32). The sacrificial photoresist is then removed, lifting off the unwanted metal, defining the pattern (33). The Aqua Regia Etch method includes the deposition of the metallic layers (34) and then the Aqua Regia Etch (35) to define the required metallic pattern.

The underlying silicon oxide layer is patterned by photolithography and then etched via a buffered oxide wet etch (36). The PZT sol-gel can be deposited and patterned in two separate processes—lift-off (37-40) and a wet etch (41-47). The method used to deposit and pattern the PZT material is sol-gel precursor dependent, with some precursors requiring high temperature thermal processing steps, rendering lift-off methods unfeasible. The lift-off procedure begins with the spinning of sacrificial photoresist and the spin deposition of the PZT material (37). The sacrificial photoresist is then removed, patterning the PZT layer, then crystallizing the remaining PZT with an anneal (38). The top platinum electrode is then deposited and patterned by a lift off procedure. The first step is to deposit a sacrificial photoresist (39), deposit the platinum, and then remove the sacrificial material to pattern the top platinum layer (40).

If the PZT material is to be wet etched, the first step of the process is to spin deposit the PZT material on the entire wafer (41). The PZT is then patterned through photolithography (42), and wet etched using a multistep wet etch (43). In this case, the top platinum electrode is then deposited through lift off (44-45). The wet etch typically leaves a residue on the exposed silicon oxide layer that requires removal. The etch areas are defined through photolithography (46) and etched (47) in a prolonged buffered oxide etch. The release of the harvester involves two sequential ICP-RIE etch steps. The first etch defines the geometry of the folded spring from the front side of the wafer (48). The second etch ICP-RIE etches deep wells on the backside of the wafer (49). The combination of these etches releases and defines the thickness of the beams of the energy harvesters (50).

Aqua Regia Etch System

The Aqua Regia etch is a wet chemical etch used to pattern platinum layers of the energy harvester. Platinum is a very robust and is etch-resistant material. Aqua Regia, a 3:1 ratio of Hydrochloric and Nitric Acids, is one of the few etchants capable of etching Platinum. A system to allow for the control of the etch process, includes solution temperature, agitation, removal of the by-product chlorine gas, and the aspiration of the waste solution.

The purpose of the Aqua Regia Etch System (“ARES”) is to allow the safe and repeatable etching of Titanium and Platinum films for microfabrication purposes. The etch process involves a heated 3:1 mixture of hydrochloric and nitric acids etching exposed Titanium and Platinum films. A by-product of this microfabrication process is chlorine gas, which can be a safety hazard. Therefore, it is necessary to properly handle and dispose the chlorine gas produced from this reaction. The exhaust gasses are bubbled through a gas wash bottle in order to dissolve the hazardous chlorine gas into a weak hydrochloric acid. The etch system is completely self-contained, having its own inlets for deionized water for dilution/quenching, power for the heating element, such as a hotplate, and vacuum for exhaust removal; and outlets for aspirated waste solution and vacuum exhaust. This system allows for the controlled, repeatable, cost effective, and safe etching of Platinum and Titanium in for microfabrication purposes, without placing those working nearby at risk.

The ARES is composed of four major subsystems: a glovebox, a reaction chamber, an exhaust handling system, and an aspiration/rinse system. These systems all operate concurrently in order to etch Platinum and Titanium films.

The entire ARES system is contained within a glovebox. The ARES can operate independently of fumehood, if properly vented with vacuum. In addition, the glovebox gives an added layer of protection to the user of the system. The glovebox allows for the use of chemically resistant black butyl gloves while operating the ARES. The gloves are fixed to the port holes on the glovebox using a suitably large pipe clamp. Black butyl is highly chemical resistant, and will protect the operator from accidental exposure to a small volume of liquid Aqua Regia.

A heating source, such as a hotplate is used to heat the chemical solution in the reaction chamber. Since the potential for some leakage from the reaction chamber exists during etching, a folded sheet steel cowl may be used to protect the hotplate. Any material with reasonable thermal conductivity would be suitable. However, with the addition of a metal cowl to the system, the hot plate set point temperature should be calibrated to apply the appropriate reaction temperature to the glassware previous to processing. Power is provided to the hotplate inside the glovebox via a power cord threaded through a fitting, such as a Swagelok fitting, on the side of the glovebox. In addition, the power cord passes through a protective splash guard that rests on top of the hotplate, as well as the access port of the fumehood. The power cord is plugged into the receptacle on the front of the fumehood when the hot plate is required.

The glovebox may also have a pass-through load lock. In the case of the ARES, this load lock is useful for storing the chemicals (before processing) and empty glassware (after processing) preventing the reactants from mixing outside of the reaction chamber. The location of the load lock should be convenient for this purpose while manipulating the etch rig with the black butyl gloves.

The Aqua Regia etch takes place in the reaction chamber of the ARES. The reaction chamber itself includes glassware, such as three pieces nested to ensure that a vacuum induced airflow draws the produced chlorine gas off of the inner most piece of glassware. The reaction between the Aqua Regia and the Titanium and Platinum takes place inside the glassware nested glassware.

In an embodiment of the ARES, the inner most glassware is a 1.75 L Pyrex crystallization dish. This crystallization dish is large enough to accommodate a single 6″ silicon wafer or a 5″ square photolithography mask. The second piece of glassware, which is placed over top of the crystallization dish, is a bell jar. The bell jar is slightly wider than the crystallization dish. The bell jar has been configured to allow for vacuum and deionized water inlets. During operation, air and expelled chlorine gas are drawn across the top of the reaction beaker and bubbled through a gas scrubber positioned behind the bell jar. Stopcock valves are used to throttle the flow rates of air inside the bell jar. The valves are usually left open, but if need be, the flow rate can be manipulated. A pin valve at the top of the bell jar controls inlet deionized water, which will quench the reaction when required. Another valve is connected to the manifold of the rinse/aspiration system via a Teflon tube and a Swagelok connection. The outer most glassware is a circular Pyrex dish that acts as the catch-all for water drips during quenching. During processing, the whole nested glassware setup is heated by the hotplate below.

The exhaust system of the ARES dissolves the chlorine gas exhaust from the reaction chamber using a gas wash bottle. The bell jar of the reaction chamber is connected to the gas wash bottle by Teflon tubing and pipe clamps. In the gas wash bottle the exhaust chlorine gas is bubbled through deionized water, producing a weak hydrochloric acid. The exhaust of the gas wash bottle is then routed to the outside of the glovebox through a stainless steel Swagelok connection to a vacuum flask using Teflon tubing. This vacuum flask acts as a moisture trap to prevent liquids to be drawn into the house vacuum. The vacuum flask is connected to house vacuum with Teflon tubing. The flow rate of the exhaust system is controlled by the amount of suction provided by the house vacuum, and the throttling stopcock valves on the bell jar.

The aspiration/rinse system of the ARES has two separate loops controlled by a Teflon manifold with two ball valves. The rinse loop of the system is controlled by at valve and connects the manifold to the top pin valve of the bell jar through a Swagelok connection. This loop allows for the quenching/rinsing of the Aqua Regia solution without having to lift or move the bell jar, by simply opening two valves in succession. The aspiration loop of the system is controlled by a second valve. The line is passed through into the glovebox using a Swagelok connection. A Teflon “T” intersection allows for a Teflon rinse gun to be used to additionally rinse the glassware if required. The Teflon “T” intersection is connected to a stainless steel 10:1 aspirator using Teflon tubing. The aspirator acts as a venturi to create suction on a secondary line which is used to remove and dissolve the quenched Aqua Regia from the reaction chamber. The waste solution is then removed from the system through another Swagelok connection, and then is routed to a drain. The aspiration loop can be open the whole time the ARES is in use, while the rinse loop should be closed until quenching is required

The ARES system can provide repeatable etching of Platinum/Titanium films using a heated solution of Aqua Regia with an etch rate of approximately 12-15 nm/min. The ARES system provides a heated Aqua Regia Etch, which increases the etch rate of the reaction. Heating the solution increases the formation of chlorine gas. The ARES system is specifically designed to handle these increased gasses, allowing for increased etch rates. The ARES system also allows for quick and safe disposal of the Aqua Regia solution after processing (3:1 Hydrochloric to Nitric Acids). The solution can be diluted up to 17.5:1 (depending on amount of Aqua Regia used) in the reaction chamber with no “hands-on” interaction with the solution. Additionally, while being aspirated, the solution is diluted an additional 10:1 (current aspirator). This brings the dilution to approximately 175:1. The aspirator dilution ratio can be altered by using a different aspirator.

PZT Deposition and Lift-Off

To pattern a PZT film, the deposition and lift-off should occur in tandem. A sacrificial layer of photoresist is deposited and patterned, to prevent the PZT film from adhering to the wafer in areas that the PZT film is not required. The PZT sol-gel film is formed by spinning a viscous precursor solution on to the wafer and then soft-baking the wafer on a hot plate. This evaporates the solvent from the sol-gel precursor, leaving a thin film of semi-solid PZT. A partial anneal is used to solidify the film to allow for lift off to occur. After the partial anneal, an ultrasonic acetone bath is used to dissolve the sacrificial photoresist and remove the unwanted PZT film. The remainder, now patterned PZT film, is then annealed to form the required pervosikite crystal structure. This method of PZT deposition is capable of producing films as thick as 3 μm.

Packaging

The energy harvesters are capable of being packaged onto flexible and regular printed circuit boards (FPCB/PCB). This allows the energy harvesters to be characterized in-situ exposed to a base vibration. For these devices, it is not possible to simply probe the energy harvesters in a probing station, since the devices will be under a base excitation, hence the devices will be constantly moving in and out of the plane of the electrical probes. An FPCB is a flexible circuit board, made of a biocompatible polymer, such as Kapton, which provides mechanical flexibility to the circuit board to allow it to be integrated into various positions or implants. Solid fibreglass PCBs are useful for integration into common electronics. Additionally solid PCBs are more cost effective and easier to package the harvesters with in difficulty and time.

To mechanically integrate the piezoelectric energy harvester into the F/PCB, the energy harvester is adhered to the F/PCB using an acrylocynite glue. The acrylocynite glue is biocompatible, and strongly adheres the silicon base of the energy harvester to the F/PCB. In the case of FPCB, additional steps to stabilize the FPCB may be taken to prevent delamination of the energy harvester or any wire bonds. Solid PCBs and FPCBs may be designed to package individual harvesters.

The solid PCBs may be a single layer fibreglass, with a single top layer of copper/solder paste traces. The PCBs may be ordered in a large sheet, and then broken down into individual PCBs designed for each individual cleaved harvester chip. The solder paste layer is removed in order to bond, using for example a wirebond, directly onto the copper trace. Additionally, in order to allow free vibration and to increase yield of the mechanical packaging, a hole may be punched in the PCB where the mass is expected to be. The prepared PCB allows for the direct mounting of a harvester chip without spacers, reducing the required handling and potential for damage.

Examples of completely packaged harvesters can be seen in FIG. 11. The typical package includes a printed circuit board (80) with location markers (81) to allow for easy alignment to the via (82) that allows for free vibration of the energy harvester. The harvester is wirebonded to the contact pads (84) on the PCB to the ports (83) that allow for external connection. The first step in packaging is to adhere the harvester to the PCB (85). The electrical connections are then created first through wirebonds (86) then through soldering leads from the outlet ports (87).

The second class of energy harvesters uses seismic masses and arrays of harvesting elements to further drive down the natural frequency of the energy harvester. In this class of energy harvester, four major design parameters include: the number of folds in the flexible element, the number of masses in the system, the configuration of the flexible elements, and the orientation of the flexible elements. The masses and springs may be arranged in parallel and series configurations to allow for a wider variety of designs and applications. The parallel designs allow for a good balance between stability and reduction of natural frequency to allow for higher acceleration load applications. The series designs allow for the further natural frequency reduction through addition of additional masses.

The orientation of the spring elements is varied to take advantage of either pure bending or torsion-based motion of the suspended masses. Torsional-based generators are stiffer than the pure bending energy harvesters, allowing for higher amplitude accelerations/larger suspended masses.

The permutations of these designs are shown in Table 3:

TABLE 3
Permutations of parameters to populate design space

| | Number | | | |
|---|---|---|---|---|
| Device | of Folds (2 | Number of | Spring | Spring |
| Class | Folds/4 Folds) | Masses | Configuration | Orientation |
| A | 2 Folds | 1 | Series | Normal/Bending |
| B | 2 Folds | 1 | Series | Rotated/Torsion |
| C | 4 Folds | 1 | Series | Normal/Bending |
| D | 4 Folds | 1 | Series | Rotated/Torsion |
| E | 2 Folds | 2 | Series | Normal/Bending |
| F | 2 Folds | 2 | Series | Rotated/Torsion |
| G | 4 Folds | 2 | Series | Normal/Bending |
| I | 2 Folds | 2 | Parallel | Normal/Bending |
| J | 2 Folds | 2 | Parallel | Rotated/Torsion |
| K | 4 Folds | 2 | Parallel | Normal/Bending |
| L | 4 Folds | 2 | Parallel | Rotated/Torsion |

The natural frequency of each design of the harvester is highly dependent on the remaining device thickness. The designs are able to cover a wide range of operational frequencies (from 45 Hz to 4000 Hz) using the same mask set by simply varying the device thickness.

Thus a variety of folded beam harvester designs are available for low frequency actuation. Both the footprint and device thickness can be chosen to optimize the mechanical performance of the harvester to a specific target application. If there are relaxed constraints on the footprint of the intended harvester, a folded spring-based harvester could be designed to fill this role with a fairly thick device thickness. This would allow the device to be actuated at the appropriate frequency, while being mechanically robust and reliable.

The harvesters produce reasonable voltage output near resonance. While being driven closer to resonance, the output voltage typically increases; however, the stability of the harvester becomes an issue. For many cases, the output open circuit voltage increased by almost a factor of 2-3 at resonance. For example, experimentation showed a few devices output close to 0.3-0.4 V before driving apart at resonance. Thicker PZT layers, which will result in higher magnitude outputs.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. An apparatus for harvesting energy from mechanical motion, comprising:
a) a piezoelectric transducer configured for converting mechanical motion into electrical energy, wherein the transducer further comprises:
i) a piezoelectric beam element that is folded into a structure that comprises at least two parallel beam lengths that define an intervening void space,
ii) a proof mass disposed at a first end of the beam element, and
iii) a clamp element disposed at a second end of the beam element; and
b) a storage element for storing electrical energy produced by the transducer.

2. An apparatus for harvesting energy from mechanical motion, comprising:
a) a piezoelectric transducer configured for converting mechanical motion into electrical energy, wherein the transducer further comprises:
i) a piezoelectric beam element that is folded into a structure that comprises at least two parallel beam lengths that define an intervening void space between each of the beam lengths,
ii) a first clamp disposed at a first end of the beam element, and
iii) a second clamp element disposed at a second end of the beam element; and
b) a storage element for storing electrical energy produced by the transducer.

3. The apparatus of claim 2, wherein the transducer comprises a plurality of folded beam elements arranged in a parallel.

4. The apparatus of claim 2 wherein the transducer comprises a plurality of folded beam elements arranged in series.

5. The apparatus of claim 2 wherein the piezoelectric beam element includes a piezoelectric thin film.

6. The apparatus of claim 5 wherein the piezoelectric thin film is a lead zirconate titanate (“PZT”) thin film.

7. A method for manufacturing the apparatus of claim 2, the method comprising the step of using an aqua regia etching and lead zirconate titanate (“PZT”) sol-gel deposition/patterning process to manufacture the apparatus.

8. A method of manufacturing a piezoelectric transducer configured for converting mechanical motion into electrical energy, wherein the transducer includes a piezoelectric beam element that is folded into a structure that comprises at least two parallel beam lengths that define an intervening void space, comprising the steps of:
a) providing a silicon wafer;
b) depositing titanium and platinum metallic layers on the wafer;
c) defining a pattern on the metallic layers;
d) depositing a PZT sol-gel;
e) patterning the PZT sol-gel;
f) etching a geometry for the folded piezoelectric beam element.

9. The method of claim 8 wherein the titanium and platinum layers are deposited using aqua regia etching.

10. The method of claim 8 wherein the titanium and platinum layers are deposited using a lift-off process.
